(19) United States
(12) Patent Application Publication
(10) Pub. No.: US 2024/0250969 A1
(43) Pub. Date: Jul. 25, 2024

(54) DETECTION OF A REWIND ATTACK AGAINST A SECURE ENCLAVE

(71) Applicant: R3 Ltd., London (GB)

(72) Inventors: Richard G. Brown, London (GB); Qurratul Ain Shams Asari, London (GB)

(21) Appl. No.: 18/101,006

(22) Filed: Jan. 24, 2023

(51) Int. Cl. H04L 9/40; H04L 9/14

(52) U.S. Cl. CPC H04L 63/1425; H04L 9/14

(57) ABSTRACT

In some aspects, a computing system may provide a mechanism for periodic communication between the secure enclave and client devices. Specifically, the secure enclave may send a heartbeat message that the client device expects to receive within a threshold time period. The heartbeat message may include an old value that was previously sent to the client device and a new value. The client device can confirm that the old value matches what was previously sent (e.g., in a previous heartbeat message) by the secure enclave to confirm that a rewind attack has not occurred.

### SUMMARY

A secure enclave may store application information in storage that later needs to be retrieved. The application information that is stored may represent the current version of the application information. When the application information is later retrieved by the secure enclave, the secure enclave can continue its execution with that application information. For example, a secure enclave receives messages from multiple client systems and stores those messages in storage. The secure enclave may need to perform computations based on those messages and store the results of the computations for later processing when a subsequent message is received. If the secure enclave needs to restart execution, it may lose its current state (e.g., memory is cleared). In such a case, the secure enclave may need to rely on application information that has been stored persistently. After restart, the secure enclave retrieves the application information and continues execution.

Unfortunately, a malicious actor may attempt to mount a “rewind” attack against the secure enclave. A malicious actor (e.g., computer code) may intercept and store the application information each time it is updated by the secure enclave. The malicious actor thus maintains multiple prior “snapshots” of the application information. When the secure enclave restarts and retrieves its application information, the malicious actor may provide a snapshot of the application information that is not the most current. When the secure enclave does not maintain state across restarts, the secure enclave may not be able to detect that it has been provided application information that is not the most current, which can present problems. For example, an organization that publishes a commodity index may, after restart, receive some pricing information and then decide to calculate an index based on that new pricing information and the pricing information previously received. If the secure enclave is provided a snapshot of the application information that is not the most current, the secure enclave will calculate the index using some out-of-date information and publish an index that is not accurate. Such an attempt by a malicious actor to provide a snapshot that is not the most current is referred to as a “rewind” attack because the application information is effectively rewound to a prior time. Since the application information is stored in encrypted form, the malicious actor cannot alter the information but can nevertheless provide encrypted, out-of-date application information as a rewind attack. In addition, a malicious actor may also intercept messages sent to the secure enclave and store them and resend them at a later time to effectively replay the messages. Such replaying may allow the malicious actor to determine the content of a message that the malicious actor is not authorized to access.

Further, client devices that communicate with the secure enclave may be unable to determine whether a rewind attack has occurred. For example, each time a client device communicates with the secure enclave, the secure enclave may send back a message. The message may include information (e.g., random numbers) that is stored in a storage associated with the secure enclave. If a rewind attack occurs and causes the information in storage to change, then the secure enclave may send different information to the client device and because the information is different, the client device may know that a rewind attack has occurred. However, the client device may only find out that a rewind attack has occurred after communicating with the secure enclave. If the client device does not communicate with the secure enclave then it may not know that there was a rewind attack. Thus, it may be possible for a rewind attack to occur and a substantial amount of time pass before a client device finds out. This could enable malicious actors to take advantage of the client device's lack of awareness of the rewind attack.

To address these and other issues with existing systems, methods and systems described herein provide mechanisms for periodic communication between the secure enclave and client devices. Specifically, the secure enclave sends a heartbeat message that the client device expects to receive within a threshold time period. The heartbeat message can include an old value that was previously sent to the client device and a new value. The client device can confirm that the old value matches what was previously sent (e.g., in a previous heartbeat message) by the secure enclave to confirm that a rewind attack has not occurred. In some implementations, the client can, at regular intervals, send heartbeat messages to the enclave and expect a response within a certain time window. By sending/receiving heartbeat messages to/from client devices, the secure enclave can improve the security of the secure enclave system by providing a way for client devices to confirm whether a rewind attack has occurred.

In some aspects, a computing system obtains a first message from a client device, wherein the first message comprises data associated with a distributed ledger. The first message can be encrypted via a public key of the secure enclave. The private key that is associated with the public key is not readable by the host computing system. The computing system can process the data to generate updated data for the distributed ledger. The computing system stores the updated data on the host computing system, wherein the updated data is encrypted via the secure enclave. The computing system generates a first value, which is mapped to the updated data and indicates a change has occurred to data stored by the secure enclave. The computing system retrieves from a secure storage of the secure enclave a second value. The second value may have been sent to the client device in a previous message. Based on determining that a threshold time interval has passed since sending the second value, the computing system sends a heartbeat message to the client device, wherein the heartbeat message comprises the first value and the second value, which can both be random numbers used to verify a state of data stored by the secure enclave and detect whether a rewind attack has been performed on the secure enclave. Based on the heartbeat message, the computing system can obtain, via the client device, an indication that no rewind attack has occurred.

The key point which makes the application information resist to rewind is that these two values (per client) are stored alongside the application information in one single blob of data. This means the attacker is not able to separate the actual application information from this metadata. As a result, when the attacker does rewind the application information state, they also rewind the client values metadata as well. This then means when the enclave subsequently communicates with a client, the values that are sent in the message to the client will not match up with what the client previously had received, hence detecting the rewind attack.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system that may use messages to detect or prevent cybersecurity incidents, in accordance with one or more embodiments.

FIG. 2 shows example factors that may be used to determine how often messages should be sent to a client device, in accordance with one or more embodiments.

FIG. 3 shows an example secure enclave rewind environment, in accordance with one or more embodiments.

FIG. 4 shows a flowchart of the acts involved in using use messages to detect or prevent cybersecurity incidents, in accordance with one or more embodiments.

The techniques introduced in this disclosure can be better understood by referring to the following Detailed Description in conjunction with the accompanying drawings.

### DETAILED DESCRIPTION

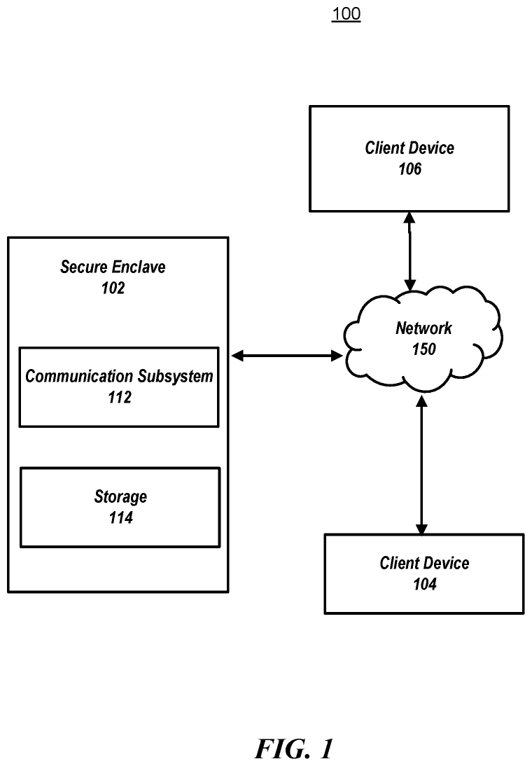

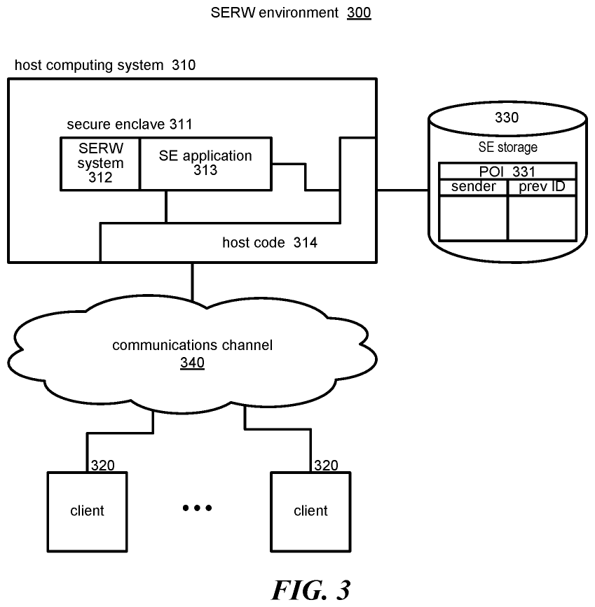

FIG. 1 shows an illustrative diagram for a system that uses heartbeat messages to detect or prevent cybersecurity incidents. The system 100 includes secure enclave 102, a client device 104, and a client device 106, any of which can communicate with each other or with other devices via a network 150. The secure enclave 102 includes a communication subsystem 112, a machine learning subsystem 114, or other components. The secure enclave 102 can be a server, a secure enclave as discussed in connection with FIG. 3 below (e.g., the secure enclave 311), or a variety of other computing devices.

Although not shown in FIG. 1, in some embodiments, the secure enclave 102 is part of a host computing system (e.g., the host computing system 310 shown in FIG. 3). The secure enclave 102 may be unable to trust the host computing system, for example, because malicious actors may gain control over the host computing system and perform a rewind attack or other malicious activity. The secure enclave 102 can use communications (e.g., messages) with client devices to help detect whether a cybersecurity incident (e.g., a rewind attack by a malicious actor in control of the host computing system) has occurred.

The secure enclave 102 can obtain a first message that includes data, for example, from the client device 104. In one example, the data can be associated with a transaction that is to be recorded on a distributed ledger. The first message may have been encrypted using a public key of a secure enclave, for example, such that the first message is not readable by the computing system. The secure enclave 102 can read the first message by decrypting the first message using a private key that is associated with the public key. The private key may be unreadable, or may be otherwise inaccessible by the computing system.

The secure enclave can process the data to generate updated data. The updated data can be used for a transaction, an action associated with a digital asset, or a variety of other actions. For example, the computing system can process the data to generate a transaction that can be recorded on a distributed ledger. As an additional example, companies that sell commodities can send pricing information to the secure enclave 102, and the commodity indices can be published via the secure enclave 102. When a message with pricing information for a commodity is received by the secure enclave 102, the secure enclave 102 can store the pricing information and eventually calculate an index for the commodity from that pricing information. An application program of the secure enclave 102 can store the pricing information in an encrypted form and persistently in storage. To calculate the index, the application program can retrieve the pricing information from storage, decrypt the pricing information, and calculate the index.

In some embodiments, generating the updated data may be associated with a metric aggregation from a single client device. For example, the client device 104 can submit, to the secure enclave, a variety of metrics that should only be reported to the untrusted host once aggregated via one or more functions. In this example, the client device 104 can select an identifier (e.g. a universally unique identifier) for a first submission to the secure enclave 102, and can increment the identifier for each data point submitted to the secure enclave 102. The secure enclave 102 can aggregate the submitted datapoints and provide them to the host computing system, for example, after a correct number (e.g., a threshold amount) of data points are submitted to the secure enclave 102.

In some embodiments, generating the updated data may be associated with multiple client devices submitting a single data point to a daily calculation. After a set of client devices (e.g., including the client device 104 and the client device 106) have submitted their corresponding data points, the secure enclave 102 can use one or more functions to generate updated data based on the data points.

In some embodiments, the secure enclave 102 can use additional information obtained from one or more client devices to assist in processing the data. For example, the secure enclave 102 may be unable to trust the host computing device to provide an accurate current time, internet protocol address, or a variety of other information that may be needed to process the data. The secure enclave 102 may rely on one or more client devices, for example, because the secure enclave 102 is unable to trust the host computing device.

The secure enclave 102 can confirm that the additional information received from a client device is accurate by comparing the additional information with information received from other client devices. The secure enclave 102 can request the information from multiple client devices. If more than a threshold number (e.g., or threshold percentage) of client devices provide the same information, the secure enclave 102 can use the information to generate the updated data. In one example, the secure enclave 102 may determine that an indication of time (e.g., timestamp) should be used in processing the data, for example, based on the first message received (e.g., the first message described above). The secure enclave 102 can retrieve a set of messages received from a set of client devices (e.g., each message in the set of messages can be obtained via a different client device of the set of client devices). The set of messages may have been received within a threshold time period (e.g., within the last minute, within the last hour, within the last day, etc.). The secure enclave 102 can determine, based on a set of timestamps associated with the set of messages, a median time and can process the data based on the median time. For example, each message can include a time stamp (e.g., an encrypted time stamp) indicating when the message was sent by a corresponding client device. The secure enclave 102 can use the median timestamp as a time for the processing, for example, to avoid the effect of outliers or to prevent reliance on potentially malicious client devices that can try to provide an incorrect timestamp.

In one example, processing the data to generate updated data can include determining (e.g., based on the first message) a variable (e.g., information) that should be used in processing the data. Based on a set of messages, the secure enclave 102 can determine a value of the variable, wherein each message of the set of messages is received from a different client device, and wherein more than a threshold percentage of messages in the set of messages indicate the value of the variable. In this example, the secure enclave 102 can process the data using the value of the variable, for example, based on the fact that more than the threshold percentage of messages indicate the value (e.g., the same value) of the variable.

The secure enclave 102 can store the updated data. For example, the secure enclave 102 can store the updated data in storage media that is shared with the computing system. The updated data can be stored in an encrypted state to prevent the host computing system from reading the updated data.

The secure enclave 102 can generate a first value associated with the updated data. The first value can be mapped to the updated data. The first value can indicate, for example, to a client device, that a change has occurred to data stored by the secure enclave 102. The first value can be a random sequence of characters (e.g., alphanumeric, etc.), a hash, or a variety of other values. By generating a value associated with a change to data stored by the secure enclave 102, the secure enclave 102 may be able to communicate the change (e.g., indicate that a change occurred) to a client device associated with the secure enclave 102. The client device may be able to use one or more values to determine whether a rewind attack has occurred at the secure enclave.

In some embodiments, the secure enclave can generate the first value by concatenating a monotonic counter value and the updated data. The secure enclave can generate a hash of the concatenation, and the hash can be used as the first value. By doing so, the first value may be based on the updated data, making the first value more difficult to determine by a malicious actor. This may make the secure enclave 102 and associated client devices more secure and resilient to rewind attacks or other cybersecurity incidents.

The secure enclave 102 can retrieve a second value from storage. The second value can be a value that was previously sent to a client device. For example, the second value may have been sent in a message to a client device to indicate to the client device a status of data stored by the secure enclave 102. As an additional example, the second value may have been sent in a previous heartbeat message (e.g., the last heartbeat message sent to the client device). The second value may be mapped to a previous update made to data via the secure enclave 102. The second value can be a random sequence of characters (e.g., alphanumeric, etc.), a hash, or a variety of other values.

The secure enclave 102 can send a message that includes the first value and the second value. The message can be sent to one or more client devices to enable the client devices to determine whether a cybersecurity attack has occurred, for example, at the secure enclave 102. The first value and second value can be random numbers used to verify a state of data stored by the secure enclave 102 and detect whether a rewind attack has been performed on the secure enclave 102.

In some embodiments, the client device 104 can send heartbeat messages to the secure enclave 102. A heartbeat message can indicate to the secure enclave 102 that the first and second value should be sent to the client device 104. For example, based on obtaining a heartbeat message or other message, the secure enclave 102 can cause (e.g., via a host computing device) the first value and the second value to be sent to the client device. The client device 104 can send heartbeat messages to the secure enclave 102 at regular intervals (e.g., every minute, every hour, every day, etc.). The client device 104 can determine that a cyber security incident has occurred, for example, based on failing to receive a response to a heartbeat or other message within a threshold period of time. Based on not receiving a response to a message within the threshold period of time, the client device 104 can send a message to the client device 106. The message sent to the client device 106 can indicate that information obtained from the secure enclave 102 should not be trusted.

In some embodiments, a client device can indicate how often a message (e.g., a message that can be used to detect whether a cybersecurity incident has occurred) should be sent. For example, the client device can indicate that a heartbeat message should be sent every four hours, every day, every hour, etc. The secure enclave 102 can obtain data (e.g., from the client device and via a host computing device) indicating how often a heartbeat message should be sent to the client device. Based on the data, the secure enclave 102 can send a heartbeat message to the client device.

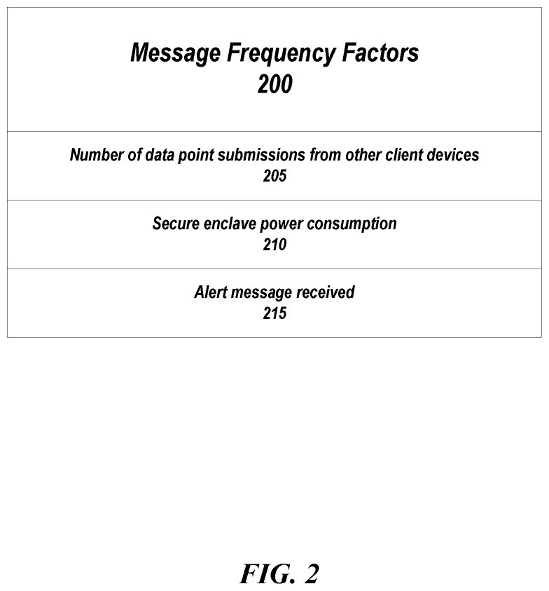

In some embodiments, the secure enclave 102 can determine how often a message (e.g., a heartbeat message) should be sent to one or more client device. The secure enclave 102 can adjust the frequency with which messages are sent to the client device 104 or can determine that a message should be sent to a client device based on an event regardless of whether the timing of the message matches a pre-determined frequency. For example, referring to FIG. 2, example factors 200 that can be used to determine how often a message should be sent to a client device are shown. According to factor 205, the secure enclave 102 can determine that the frequency with which a message should be sent should be adjusted based on the number of data point submissions from client devices. For example, if the number of data point submissions exceeds a threshold amount (e.g., within a time period such as one hour, one day, etc.), the secure enclave can determine that messages should be sent to client devices more often. The secure enclave can increase the frequency of messages to better keep client devices informed regarding changes that may be occurring to data stored at the secure enclave.

According to factor 210, the secure enclave 102 can determine that the frequency of messages should increase based on the amount of power consumed by the secure enclave. For example, if the secure enclave 102 consumes an increasing amount of power (e.g., higher than a threshold amount of power consumption), for example, due to increased computation occurring at the secure enclave, client devices may need to be informed more frequently to prevent potential cyber security incidents. Alternatively, if power consumption of the secure enclave decreases (e.g., lower than a threshold amount of power consumption), the secure enclave 102 can determine that messages should be sent less frequently (e.g., because less activity is occurring).

According to factor 215, the secure enclave 102 can determine that a message should be sent to a client device based on an alert message received. For example, the secure enclave 102 can receive an alert message indicating that a value in a message sent from the secure enclave 102 to the client device 106 does not match the expected value. Based on the values not matching the, secure enclave 102 can determine that a cyber security incident has occurred. Based on the values not matching, the secure enclave 102 can determine that other client devices should be notified that a cyber security incident may have occurred. For example, the secure enclave can send a message to the client device 104 to indicate that a cyber security incident has occurred.

Referring back to FIG. 1, the secure enclave 102 can obtain an indication of whether a cybersecurity incident has occurred, for example, from one or more client devices or the host computing system. For example, the secure enclave 102 can obtain, via the client device, an indication that no rewind attack has occurred. After determining that the second value received in the message matches a value that was previously sent to a client device, the client device can send an indication to the secure enclave 102 that the values match or that no rewind attack has occurred. The message can be encrypted (e.g., via a public key associated with the secure enclave 102) so that the message cannot be read by the host computing system (e.g., to make sure that only the secure enclave 102 can read the message). Alternatively, the secure enclave 102 can obtain an indication that a rewind attack or other cybersecurity attack has occurred. For example, if the second value does not match a value that was previously sent to the client device, the client device can send (e.g., to the secure enclave 102) a message indicating that a rewind attack or other cybersecurity incident has occurred.

In some embodiments, the secure enclave 102 can use a monotonic counter to prevent rewind attacks or other cybersecurity incidents from occurring. A monotonic counter can be a counter that can only go forward, but not backward. The monotonic counter can be accessed within the secure enclave (e.g., without needing to go through an external device or a host device). The monotonic counter can be implemented with a dedicated electronic circuit attached to a storage (e.g., memory storage).

By using a monotonic counter, the secure enclave may be able to prevent a rewind attack or other cybersecurity incident. For example, a malicious actor might pause or temporarily stop operations of the secure enclave, make a copy of data stored on a storage medium associated with the secure enclave, restart the secure enclave, allow the secure enclave to do some work for remote clients, pause the secure enclave again and then replace the stored data with the copy made previously. Deterministic keys can be used by the secure enclave to digitally sign and encrypt any stored data, thus preventing the host from reading or tampering with it, but cryptography may be unable to stop the malicious actor from feeding the secure enclave older versions of the data produced by the secure enclave.

Through use of a monotonic counter the secure enclave can increment the monotonic counter and encrypt the value (e.g., the value that the monotonic counter was incremented to) alongside any data the secure enclave determines to store. After the secure enclave reloads the data, the secure enclave can compare the value the secure enclave previously stored to the current value of the counter and ensure the values match. If the values do not match, the secure enclave can determine that data of the secure enclave has been tampered with (e.g., the current data has been replaced with an old version of the data) and the secure enclave can determine to pause or cease operations in response.

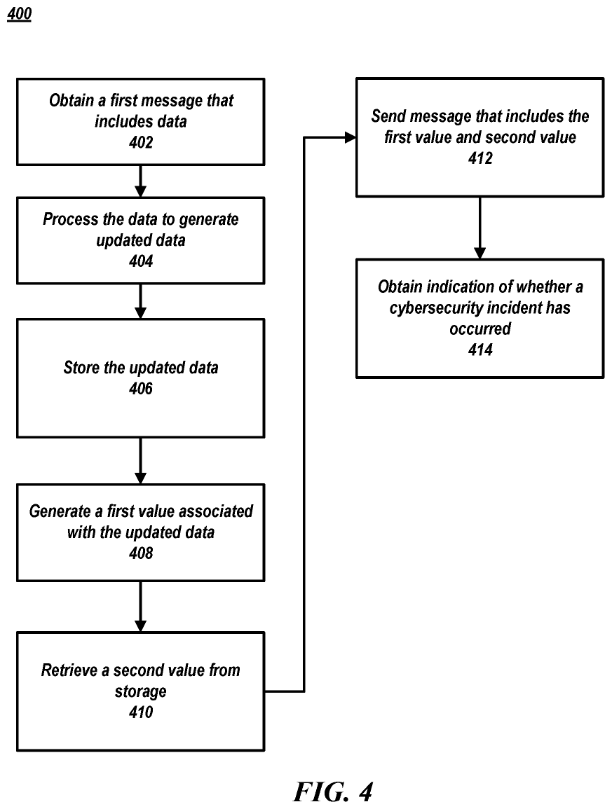

FIG. 3 is a diagram that illustrates an example secure enclave rewind (SERW) environment. The SERW environment 300 may be used to send messages to client devices or perform any other actions described in connection with FIG. 1 or FIG. 4. The secure enclave 311 may determine whether state information retrieved from storage is consistent with data that is received from clients (“client data”) and/or represents a version of the state information that is not current. In some embodiments, a secure enclave (“SE”) application executing in a secure enclave may employ a SERW system to help detect rewind attacks by a host computer system that hosts the secure enclave. The SERW system helps ensure that a rewind attack by a malicious actor of a host computing system can rewind only to state information that is consistent with replayed client data. The SERW system can also detect that the state information is possibly not current in some instances. As used herein, the term “application” may refer to a computer program that is either an application program or a system program.

The SERW system can verify whether client data and state information provided by the host computing system are consistent or inconsistent and/or whether state information is not current. If inconsistent or not current, then the SERW system may notify the SE application so that appropriate countermeasures can be taken. The inconsistency may be a result of, for example, a malicious actor (e.g., the host computing system or a client) (1) providing state information that is an out-of-date version of the state information (e.g., a rewind attack), (2) replaying client data that is already reflected in the state information (i.e., old client data), or (3) providing client data that indicates that not all prior client data is reflected in the state information, referred to as a “gap” in client data.

In some embodiments, an SERW environment 300 includes a host computing system 310, client systems 320, SE storage 330, and a communications channel 340. The host computing system includes a secure enclave 311 and host code 314 that may be malicious. An SERW system 312 and an SE application 313 execute within the secure enclave environment. The client systems communicate with the host computing system via the communications channel. The host computing system receives encrypted client data from the client systems and encrypted application data (e.g., emails) from the SE storage and provides the encrypted data to the SE application. The host computing system receives encrypted application data from the SE application and stores the encrypted application data to the SE storage. The SE storage stores SE application data and state information that may include the POI table 331, which contains a record for each sender and the previous ordering information of the sender. The SE storage may be any type of persistent storage. Rather than being stored in SE storage, the state information may alternatively be stored in a state message that the SE application sends to itself.

In some embodiments, the code of the SERW system may be part of the SE application (e.g., within executable code of the SE application) or a separate service provided to the application. In addition, some of the functions of the SERW system may be implemented as part of the application and other functions may be provided by the separate service. For example, the host computing system may provide messages directly to the SE application, and the SE application may invoke components of the separate service to verify that the messages and state information are consistent. Alternatively, the host computing may provide messages directly to the SERW system as a separate service which verifies the messages and provides them to the SE application.

The term “secure enclave” may refer to a feature of a central processing unit (CPU) in which code and data of code (e.g., trusted code) are stored in external memory or persistent storage in encrypted form and may be decrypted when retrieved for use by the CPU. Such code may execute in the secure enclave. A secure enclave may have internal memory that is used by code executing within the secure enclave to store its data that includes its state. The internal memory is, however, not persistent. When the secure enclave halts execution (e.g., host computing system is rebooted), the state stored in the internal memory may be lost. In some embodiments, after the secure enclave restarts execution, the internal memory may no longer store the state. Execution of the code may cause retrieval of the state from an external source to resume execution based on the state of the code when execution of the secure enclave halted.

To ensure that the code executing in a secure enclave is trusted code (e.g., the code that is expected), the CPU supports generating an attestation of the trusted code (e.g., the SE application and the SERW system) that executes in the secure enclave. The attestation includes a hash of the trusted code, an identifier of the CPU, and application data. The attestation is encrypted or signed by a CPU private key of a CPU public/private key pair that is stored in the CPU during manufacture of the CPU. The trusted code requests the CPU to provide the attestation and then provides the attestation to client code as evidence of the trusted code that executes in the secure enclave. The client code can request a service (of the manufacturer of the CPU) to provide the CPU public key of the CPU public/private key pair to decrypt or verify the signature. The client code can extract the hash to verify that the trusted code is the expected code and extract the application data.

Application data of an application that is executing within a secure enclave is encrypted before being stored in storage and decrypted when retrieved from storage. In addition, client data (e.g., messages) received from client systems is encrypted and decrypted after being received. Similarly, data sent to client systems is encrypted and then decrypted by the client system. The data is considered to be stored in an encrypted form. The data can be encrypted and decrypted either by the application or the secure enclave environment provided by the hot computing system. When data is described without the adjective “decrypted” or “encrypted,” it is considered to be in an unencrypted form whether decrypted from encrypted data or created in an unencrypted form.

The computing systems (e.g., nodes) on which the SERW system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the SERW system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SERW system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the SERW system may be implemented in hardware using, for example, an application-specific integrated circuit (ASIC) or field programmable gate array (“FPGA”).

FIG. 4 shows a flowchart of the acts involved in using messages to prevent rewind attacks, in accordance with one or more embodiments. Although described as being performed by a secure enclave of a computing system (e.g., a host computing system), one or more actions described in connection with process 400 of FIG. 4 may be performed by one or more devices described in connection with FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At act 402, a secure enclave may obtain a first message that includes data. For example, a secure enclave that is hosted on a computing system, may obtain the first message. In one example, the data may be associated with a transaction that is to be recorded on a distributed ledger. The first message may have been encrypted using a public key of a secure enclave, for example, such that the first message is not readable by the computing system. The secure enclave may read the first message by decrypting the first message using a private key that is associated with the public key. The private key may be unreadable, or may be otherwise inaccessible by the computing system.

At act 404, the secure enclave may process the data to generate updated data. For example, the computing system may process the data to generate a transaction that can be recorded on a distributed ledger. In some embodiments, the secure enclave may use additional information obtained from one or more client devices to assist in processing the data. For example, the secure enclave may be unable to trust the host computing device to provide an accurate current time, internet protocol address, or a variety of other information that may be needed to process the data. The secure enclave may rely on one or more client devices, for example, because the secure enclave is unable to trust the host computing device.

The secure enclave may confirm that the additional information received from a client device is accurate by comparing the additional information with information received from other client devices. The secure enclave may request the information from multiple client devices. If more than a threshold number (e.g., or threshold percentage) of client devices provide the same information, the secure enclave may use the information to generate the updated data. In one example, the secure enclave may determine that an indication of time (e.g., time stamp) should be used in processing the data, for example, based on the first message received in act 402. The secure enclave may retrieve a set of messages received from a set of client devices (e.g., each message in the set of messages may be obtained via a different client device of the set of client devices). The set of messages may have been received within a threshold time period (e.g., within the last minute, within the last hour, within the last day, etc.). The secure enclave may determine, based on a set of timestamps associated with the set of messages, a median time and may process the data based on the median time. For example, each message may include a time stamp (e.g., an encrypted time stamp) indicating when the message was sent by a corresponding client device. The secure enclave may use the median timestamp as a time for the processing, for example, to avoid the effect of outliers or to prevent reliance on potentially malicious client devices that may try to provide an incorrect timestamp.

In one example, processing the data to generate updated data may include determining (e.g., based on the first message) a variable (e.g., information) that should be used in processing the data. Based on a set of messages, the secure enclave may determine a value of the variable, wherein each message of the set of messages is received from a different client device, and wherein more than a threshold percentage of messages in the set of messages indicate the value of the variable. In this example, the secure enclave may process the data using the value of the variable, for example, based on the fact that more than the threshold percentage of messages indicate the value (e.g., the same value) of the variable.

At act 406, the secure enclave may store the updated data. For example, the secure enclave may store the updated data in storage media that is shared with the computing system. The updated data may be stored in an encrypted state to prevent the host computing system from reading the updated data.

At act 408, the secure enclave may generate a first value associated with the updated data. The first value may be mapped to the updated data. The first value may indicate, for example, to a client device, that a change has occurred to data stored by the secure enclave. The first value may be a random sequence of characters (e.g., alphanumeric, etc.), a hash, or a variety of other values. By generating a value associated with a change to data stored by the secure enclave, the secure enclave may be able to communicate the change (e.g., indicate that a change occurred) to a client device associated with the secure enclave. The client device may be able to use one or more values to determine whether a rewind attack has occurred at the secure enclave.

In some embodiments, the secure enclave may generate the first value by concatenating a monotonic counter value and the updated data. The secure enclave may generate a hash of the concatenation, and the hash may be used as the first value. By doing so, the first value may be based on the updated data making the first value more difficult to determine by a malicious actor. This may make the secure enclave and associated client devices more secure and resilient to rewind attacks or other cybersecurity incidents.

At act 410, the secure enclave may retrieve a second value from storage. The second value may be a value that was previously sent to a client device. For example, the second value may have been sent in a message to a client device to indicate to the client device a status of data stored by the secure enclave. As an additional example, the second value may have been sent in a previous heartbeat message (e.g., the last heartbeat message sent to the client device). The second value may be mapped to a previous update made to data via the secure enclave. The second value may be a random sequence of characters (e.g., alphanumeric, etc.), a hash, or a variety of other values.

At act 412, the secure enclave may send a message that includes the first value and the second value. The message may be sent to one or more client devices to enable the client devices to determine whether a cybersecurity attack has occurred, for example, at the secure enclave. The first value and second value may be random numbers used to verify a state of data stored by the secure enclave and detect whether a rewind attack has been performed on the secure enclave.

In some embodiments, a client device may indicate how often a message (e.g., a message that can be used to detect whether a cybersecurity incident has occurred) should be sent. For example, the client device may indicate that a heartbeat message should be sent every four hours, every day, every hour, etc. The secure enclave may obtain data (e.g., from the client device and via a host computing device) indicating how often a heartbeat message should be sent to the client device. Based on the data, the secure enclave may send a heartbeat message to the client device.

At act 414, the secure enclave may obtain an indication of whether a cybersecurity incident has occurred. For example, based on the message sent at act 412, the secure enclave may obtain, via the client device, an indication that no rewind attack has occurred. After determining that the second value received in the message matches a value that was previously sent to a client device, the client device may send an indication to the secure enclave that the values match or that no rewind attack has occurred. The message may be encrypted (e.g., via a public key associated with the secure enclave) so that the message cannot be read by the host computing system (e.g., to make sure that only the secure enclave can read the message). Alternatively, the secure enclave may obtain an indication that a rewind attack or other cybersecurity attack has occurred. For example, if the second value does not match a value that was previously sent to the client device, the client device may send (e.g., to the secure enclave) a message indicating that a rewind attack or other cybersecurity incident has occurred.

It is contemplated that the acts or descriptions of FIG. 4 may be used with any other embodiment of this disclosure. In addition, the acts and descriptions described in relation to FIG. 4 may be done in alternative orders or in parallel to further the purposes of this disclosure. For example, each of these acts may be performed in any order, in parallel, or simultaneously to reduce lag or increase the speed of the system or method. Furthermore, it should be noted that any of the components, devices, or equipment discussed in relation to the figures above could be used to perform one or more of the acts in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: obtaining, by a secure enclave of a host computing system, a first message, wherein the first message comprises data associated with a distributed ledger; processing the data to generate updated data; generating a first value, wherein the first value is mapped to the updated data and indicates a change has occurred to data stored by the secure enclave; retrieving, from a storage associated with the secure enclave, a second value, the second value having been sent to a client device in a previous message; and based on determining that a threshold time interval has passed, sending a heartbeat message to the client device, wherein the heartbeat message comprises the first value and the second value.
2. The method of any of the preceding embodiments, wherein processing the data to generate updated data comprises: based on the first message, determining that a time should be used in processing the data; retrieving a set of messages received from a set of client devices, wherein the set of messages were received within a threshold time period; determining, based on a set of timestamps associated with the set of messages, a median time; and processing the data based on the median time.
3. The method of any of the preceding embodiments, wherein processing the data to generate updated data comprises: based on the first message, determining that a variable should be used in processing the data; based on a set of messages, determining a value of the variable, wherein each message of the set of messages is received from a different client device, and wherein more than a threshold percentage of messages in the set of messages indicate the value of the variable; and processing the data based on the value of the variable.
4. The method of any of the preceding embodiments, wherein the variable comprises an indication of an Internet Protocol address of the host computing system, a version of a software application executing on the host computing system, or a hostname of the host computing system.
5. The method of any of the preceding embodiments, wherein the first value is a hash of a concatenation of a monotonic counter value and the updated data.
6. The method of any of the preceding embodiments, wherein the first message is encrypted via a public key of the secure enclave, and wherein a private key that is associated with the public key is not readable by the host computing system.
7. The method of any of the preceding embodiments, wherein the first value and the second value are random numbers used to verify a state of data stored by the secure enclave and detect whether a rewind attack has been performed on the secure enclave.
8. The method of any of the preceding embodiments, further comprising: obtaining data indicating how often a heartbeat message should be sent to the client device; and based on the data, sending a heartbeat message to the client device.
9. A tangible, non-transitory, machine-readable medium storing instructions that, when executed by a data processing apparatus, cause the data processing apparatus to perform operations comprising those of any of embodiments 1-8.
10. A system comprising one or more processors; and memory storing instructions that, when executed by the processors, cause the processors to effectuate operations comprising those of any of embodiments 1-8.
11. A system comprising means for performing any of embodiments 1-8.

What is claimed is:

1. A host computing system comprising a secure enclave that prevents malicious rewind attacks through the use of heartbeat messages, the host computing system comprising:
one or more computer-readable storage mediums for storing computer executable instructions for controlling the application of the secure enclave to perform operations comprising:
obtaining a first message from a client device, wherein the first message comprises data associated with a distributed ledger,
wherein the first message is encrypted via a public key of the secure enclave, and
wherein a private key that is associated with the public key is not readable by the host computing system;
processing the data to generate updated data for the distributed ledger;
storing the updated data on the host computing system, wherein the updated data is encrypted via the secure enclave;
generating a first value, wherein the first value is mapped to the updated data and indicates a change has occurred to data stored by the secure enclave;
retrieving from a secure storage of the secure enclave a second value, the second value having been sent to the client device in a previous message;
based on determining that a threshold time interval has passed since previously sending the second value to the client device, sending a heartbeat message to the client device,
wherein the heartbeat message comprises the first value and the second value, and
wherein the first value and the second value are random numbers used to verify a state of data stored by the secure enclave and to detect whether a rewind attack has been performed on the secure enclave; and
based on the heartbeat message, receiving, from the client device, an indication that no rewind attack has occurred.

2. The host computing system of claim 1, wherein processing the data to generate updated data comprises:
based on the first message, determining that a time should be used in processing the data;
retrieving a set of messages received from a set of client devices, wherein the set of messages were received within a threshold time period;
determining, based on a set of timestamps associated with the set of messages, a median time; and
processing the data based on the median time.

3. The host computing system of claim 1, wherein processing the data to generate updated data comprises:
based on the first message, determining that a variable should be used in processing the data;
based on a set of messages, determining a value of the variable, wherein each message of the set of messages is received from a different client device, and wherein more than a threshold percentage of messages in the set of messages indicate the value of the variable; and
processing the data based on the value of the variable.

4. The host computing system of claim 3, wherein the variable comprises an indication of an Internet Protocol address of the host computing system, a version of a software application executing on the host computing system, or a hostname of the host computing system.

5. A method comprising:
obtaining, by a secure enclave of a host computing system, a first message, wherein the first message comprises data associated with a distributed ledger;
processing the data to generate updated data;
generating a first value, wherein the first value is mapped to the updated data and indicates a change has occurred to data stored by the secure enclave;
retrieving, from a storage associated with the secure enclave, a second value, the second value having been sent to a client device in a previous message; and
based on receiving a heartbeat message from the client device, sending the first value and the second value to the client device.

6. The method of claim 5, wherein processing the data to generate updated data comprises:
based on the first message, determining that a time should be used in processing the data;
retrieving a set of messages received from a set of client devices, wherein the set of messages were received within a threshold time period;
determining, based on a set of timestamps associated with the set of messages, a median time; and
processing the data based on the median time.

7. The method of claim 5, wherein processing the data to generate updated data comprises:
based on the first message, determining that a variable should be used in processing the data;
based on a set of messages, determining a value of the variable, wherein each message of the set of messages is received from a different client device, and wherein more than a threshold percentage of messages in the set of messages indicate the value of the variable; and
processing the data based on the value of the variable.

8. The method of claim 7, wherein the variable comprises an indication of an Internet Protocol address of the host computing system, a version of a software application executing on the host computing system, or a hostname of the host computing system.

9. The method of claim 5, wherein the first value is a hash of a concatenation of a monotonic counter value and the updated data.

10. The method of claim 5, wherein the first message is encrypted via a public key of the secure enclave, and wherein a private key that is associated with the public key is not readable by the host computing system.

11. The method of claim 5, wherein the first value and the second value are random numbers used to verify a state of data stored by the secure enclave and detect whether a rewind attack has been performed on the secure enclave.

12. The method of claim 5, further comprising:
obtaining data indicating how often a heartbeat message should be sent to the client device; and
based on the data, sending a heartbeat message to the client device.

13. A non-transitory, computer-readable medium comprising instructions that when executed by one or more processors, cause operations comprising:
obtaining, by a secure enclave of a host computing system, a first message, wherein the first message comprises data associated with a distributed ledger;
processing the data to generate updated data;
generating a first value, wherein the first value indicates a change has occurred to data stored by the secure enclave;
retrieving, from a storage associated with the secure enclave, a second value, the second value having been sent to a client device in a previous message; and
based on determining that a threshold time interval has passed, sending a second message to the client device, wherein the second message comprises the first value and the second value.

14. The medium of claim 13, wherein processing the data to generate updated data comprises:
based on the first message, determining that a time should be used in processing the data;
retrieving a set of messages received from a set of client devices, wherein the set of messages were received within a threshold time period;
determining, based on a set of timestamps associated with the set of messages, a median time; and
processing the data based on the median time.

15. The medium of claim 13, wherein processing the data to generate updated data comprises:
based on the first message, determining that a variable should be used in processing the data;
based on a set of messages, determining a value of the variable, wherein each message of the set of messages is received from a different client device, and wherein more than a threshold percentage of messages in the set of messages indicate the value of the variable; and
processing the data based on the value of the variable.

16. The medium of claim 15, wherein the variable comprises an indication of an Internet Protocol address of the host computing system, a version of a software application executing on the host computing system, or a hostname of the host computing system.

17. The medium of claim 13, wherein the first value is a hash of a concatenation of a monotonic counter value and the updated data.

18. The medium of claim 13, wherein the first message is encrypted via a public key of the secure enclave, and wherein a private key that is associated with the public key is not readable by the host computing system.

19. The medium of claim 13, wherein the first value and the second value are random numbers used to verify a state of data stored by the secure enclave and detect whether a rewind attack has been performed on the secure enclave.

20. The medium of claim 13, wherein the instructions, when executed, cause operations further comprising:
based on the second message, receiving, from the client device, an indication that no rewind attack has occurred.
